(19) United States
(12) Patent Application Publication
(10) Pub. No.: US 2014/0300897 A1
(43) Pub. Date: Oct. 9, 2014

(54) SECURITY SCREENING SYSTEMS AND METHODS

(71) Applicant: CHEMIMAGE CORPORATION, Pittsburgh, PA (US)

(72) Inventors: Patrick J. TREADO, Pittsburgh, PA (US); Matthew NELSON, Harrison City, PA (US); Charles W. GARDNER, Gibsonia, PA (US)

(73) Assignee: CHEMIMAGE CORPORATION, Pittsburgh, PA (US)

(21) Appl. No.: 14/246,608

(22) Filed: Apr. 7, 2014

Related U.S. Application Data
(60) Provisional application No. 61/809,291, filed on Apr. 5, 2013.

(51) Int. Cl. G01J 3/51; G01J 3/02

(52) U.S. Cl. CPC G01J 3/51; G01J 3/0224
USPC 356/364; 356/416; 250/339.02

(57) ABSTRACT

The present disclosure describes security screening systems and methods for identifying a suspect material in a sample. In general terms, the system and method disclosed herein provide collection optics configured to collect a first plurality of interacted photons from an illuminated sample and generating a first optical signal. The first optical signal is separated into a plurality of optical components where the plurality of optical components are filtered by a plurality of filters. Each filter of the plurality of filters is configured to filter the plurality of optical components into a passband wavelength to generate a plurality of filtered components. The plurality of filtered components are detected by one or more detectors and one or more wavelength specific spectral images are generated. A processor is configured to analyze the one or more wavelength specific spectral images in order to identify the suspect material in the sample. The systems and methods disclosed herein may find particular use in a security setting.

### CROSS-REFERENCE TO RELATED APPLICATION

This applications claims benefit of and priority to U.S. Provisional Application Ser. No. 61/809,291 entitled “System and Method for Detecting Unknown Materials Using Dual Polarization and Extended Range SWIR Hyperspectral Imaging” and filed Apr. 5, 2013, the disclosure of which is incorporated by reference herein in its entirety.

### BACKGROUND

Spectroscopic imaging combines digital imaging and molecular spectroscopy techniques. Such techniques may include Raman scattering, fluorescence, photoluminescence, ultraviolet, visible and infrared spectroscopic techniques. When spectroscopic imaging is applied to the chemical analysis of materials, spectroscopic imaging is commonly referred to as chemical imaging. Instruments for performing spectroscopic (i.e., chemical) imaging typically feature an illumination source, an image gathering optic, a focal plane array imaging detector and an imaging spectrometer.

Generally, the sample size to be analyzed determines the choice of the image gathering optics. For example, a microscope is typically employed for the analysis of sub-micron to millimeter spatial dimension samples. For larger objects, in the range of millimeter to meter dimensions, macro lens optics are generally utilized. For samples located within relatively inaccessible environments, flexible fiberscope or rigid borescopes may be employed. For very large scale objects, such as planetary objects, telescopes may be appropriate image gathering optics.

For detection of images formed by the various optical systems, two-dimensional, imaging focal plane array (“FPA”) detectors are typically employed. The choice of FPA detector is governed by the spectroscopic technique employed to characterize a sample of interest. For example, silicon (Si) charge-coupled device (“CCD”) detectors or complementary metal-oxide-semiconductor (“CMOS”) detectors are typically employed with visible wavelength fluorescence and Raman spectroscopic imaging systems, while indium gallium arsenide (“InGaAs”) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, wide-field spectroscopic imaging of a sample can be implemented by collecting spectra over the entire area encompassing the sample while, at the same time, a tunable optical imaging filter may be employed. Such filters include, for example, an acousto-optic tunable filter (“AOTF”) or a liquid crystal tunable filter (“LCTF”). The tunable optical imaging filters operate in a manner such that the organic material in the filter is actively aligned by applied voltages to produce the desired bandpass and transmission of light. The spectra obtained for each pixel of such an image thereby forms a complex data set referred to as a hyperspectral image (“HSI”) which contains the intensity values at numerous wavelengths or the wavelength dependence of each pixel element in the image.

A LCTF typically uses birefringent retarders to distribute the light energy of an input light signal over a range of polarization states. The polarization state of light emerging at the output of the LCTF is caused to vary as a function of wavelength due to differential retardation of orthogonal components of the light, contributed to by the birefringent retarders. The LCTF discriminates for wavelength-specific polarization using a polarizing filter at the output. The polarizing filter passes the light components in the output that are rotationally aligned to the polarizing filter.

The LCTF is tuned by adjusting the birefringence of the retarders so that a specific discrimination wavelength emerges in a plane polarized state, aligned to the output polarizing filter. Other wavelengths that emerge in other polarization states and/or alignments are attenuated.

A highly discriminating spectral filter is possible using a sequence of several birefringent retarders. The thicknesses, birefringences, and relative rotation angles of the retarders are chosen to correspond to the discrimination wavelength. More specifically, the input light signal to the filter becomes separated into orthogonal vector components, parallel to the respective ordinary and extraordinary axes of each birefringent retarder when encountered along the light transmission path through the filter. These separated vector components are differentially retarded due to the birefringence. Such differential retardation also amounts to a change in their polarization state. For a plane polarized component at the input to the filter, having a specific rotational alignment at the input to the filter and at specific discrimination wavelengths, the light components that have been divided and subdivided all emerge from the filter in the same polarization state and alignment, namely plane polarized and in alignment with the selection polarizer (i.e., the polarizing filter) at the output.

A filter as described above is sometimes termed an interference filter given the input components are divided and subdivided and, subsequently, interfere positively at the output selection polarizer where these components are then passed to the output. Such filters also are sometimes described with respect to a rotational twist in the plane polarization alignment of the discriminated component between the input and the selection polarizer at the output.

There are several known configurations of spectral filters comprising birefringent retarders, such as the Lyot, Solc and Evans types. Such filters can be constructed with fixed (non-tunable) birefringent crystal retarders. A filter with retarders that are tuned in unison permits adjustment of the bandpass wavelength. Tunable retarders can comprise liquid crystals or composite retarder elements each comprising a fixed crystal and an optically aligned liquid crystal.

The thicknesses, or birefringences, and rotation angles of the retarders are coordinated such that each retarder contributes part of the necessary change in polarization state to alter the polarization state of the passband wavelength from an input reference angle to an output reference angle. The input reference angle may be, for example, 45° to the ordinary and extraordinary axes of a first retarder in the filter. The output reference angle is the rotational alignment of the polarizing filter or “selection polarizer.”

A spectral filter may have a comb-shaped transmission characteristic. Increasing or decreasing the birefringence when tuning to select the discrimination wavelength (or passband), stretches or compresses the comb shape of the transmission characteristic along the wavelength coordinate axis.

If the input light is randomly polarized, the portion that is spectrally filtered is limited to the vector components of the input wavelengths that are parallel to one of the two orthogonal polarization components that are present. Only light at the specific wavelength, and at a given reference polarization alignment at the input, can emerge with a polarization angle aligned to the rotational alignment of the selection polarizer at the output. The light energy that is orthogonal to the reference alignment at the input, including light at the passband wavelength, is substantially blocked.

A LCTF, thus, passes only one of two orthogonal components of input light. The transmission ratio in the passband is at a maximum for incident light at the input to the LCTF that is aligned to a reference angle of the LCTF. Transmission is at a minimum for incident light energy at the input that is orthogonal to that reference angle. If the input light in the passband is randomly polarized, the best possible transmission ratio in the passband is fifty percent. It is therefore desirable to devise a system and method wherein both orthogonal components of the input light are allowed to transmit through a tunable filter to effectively double the throughput at the filter(s) output.

Spectroscopic devices operate over a range of wavelengths due to the operation ranges of the detectors or tunable filters possible. This enables analysis in the Ultraviolet (UV), visible (VIS), near infrared (NIR), short-wave infrared (SWIR), mid infrared (MIR) wavelengths, long wave infrared wavelengths (LWIR), and to some overlapping ranges.

There currently exists a need for a security screening system to accurately identify suspect materials, including, for example, drugs, chemicals, bio-threats, and hazardous compounds, including explosives and explosive residues. In particular, there exists a need for a system and method for accurate identification of such materials where such materials may be found on transportation passengers and other individuals at security checkpoints, points of inspection and other similar locations. There also exists a need for a system and method for the detection of such materials located in or on a person or an article associated with that person, including clothing items, baggage, passports, drivers licenses, personal effects, and the like.

### SUMMARY

The present disclosure relates to security screening systems and methods for identifying suspect materials in sample. One system according to the disclosure herein includes a first collection optic configured to collect a first plurality of interacted photons from an illuminated sample and generate a first optical signal from the interacted photons. The first optical signal may be separated by a beam splitter into a plurality of optical components. A plurality of filters filter the plurality of optical components where each filter is configured to filter one of the plurality of optical components into a passband wavelength to generate a plurality of filtered components. The system further provides for one or more detectors configured to detect the plurality of filtered components and generate one or more wavelength specific spectral images of the plurality of filtered components. A processor is configured to analyze the one or more wavelength specific spectral images to identify the suspect material in the sample. In one embodiment, the system disclosed herein may further comprise a second collection optic configured to collect a second plurality of interacted photons from an illuminated sample and generate a second optical signal. The second optical signal is detected by a RGB detector which may generate a RGB image of the second optical signal.

The instant disclosure further features methods for identifying a suspect material in a sample. In one embodiment, a method includes collecting a first plurality of interacted photons from an illuminated sample to generate a first optical signal. The first optical signal is separated into a plurality of orthogonally polarized optical components. The plurality of optical components are then filtered into a plurality of passband wavelengths to generate a plurality of filtered components. The filtered components are detected to generate at least one wavelength specific spectral image. The wavelength specific spectral image is then analyzed to identify the suspect material in the sample.

The systems and methods provided herein may be utilized in security settings and security checkpoints, such as, airport security, border security, stadium security, building security, transportation security to identify suspect materials found in or on samples. Examples of samples where the systems and methods are useful include, for example, a passport, a credit card, a driver's license, a boarding pass, a human body part, a piece of clothing, a wearable item, a shoe, an airline ticket, luggage, personal effects and the like.

### BRIEF DESCRIPTION OF THE DRAWINGS

FIGS. 1A-1D illustrate security screening systems for identifying a suspect material in a sample according to embodiments;

FIG. 2 illustrates a system for identifying a suspect material in a sample according to an embodiment;

FIG. 3A illustrates detection images of samples prepared in a limit of detection (“LOD”) study for ammonium nitrate;

FIG. 3B illustrates short-wave infrared spectra associated with varying concentrations of ammonium nitrate for a LOD study;

FIG. 3C illustrates a calibration curve for concentrations of ammonium nitrate in a LOD study;

FIG. 4 illustrates a RGB image for the detection of ammonium nitrate residue on the surface of a leather shoe;

FIG. 5 illustrates the detection of ammonium nitrate deposited on the surface of a cup;

FIG. 6A illustrates a RGB/optical overlay of an on-the-move image;

FIG. 6B illustrates a RGB image of a test area;

FIG. 7 illustrates a security screening system for identifying a suspect material in a sample featuring one detector according to an embodiment;

FIG. 8 illustrates a security screening system for identifying a suspect material in a sample featuring multiple detectors according to an embodiment;

FIG. 9 illustrates an RGB image of suspect compounds suitable for identification according to an embodiment;

FIGS. 10-11 illustrate extended short-wave infrared spectra of the compounds depicted in the RGB image of FIG. 9; and

FIG. 12 is a flow-chart illustrating an illustrative method for identifying a suspect material in a sample according to an embodiment.

### DETAILED DESCRIPTION

The systems and methods disclosed herein feature the use of a chemical imaging detector for detecting and/or identifying suspect materials in a sample. In one embodiment, the chemical imaging detector is based on Hyperspectral Imaging (“HSI”) technology. HSI combines high resolution imaging with the power of massively parallel spectroscopy to deliver images having contrast that are capable of defining the composition, structure and concentration of a sample. In one embodiment, the spectrometer may employ a liquid crystal imaging spectrometer. HSI images can be collected as a function of wavelength, resulting in a hyperspectral datacube where contrast is indicative of the varying amounts of absorbance, reflectance or scatter associated with the various suspect materials present in the field-of-view (“FOV”). Because the HSI images are collected as a function of wavelength, each pixel in the hypercube has a fully resolved spectrum for the wavelength detected. The collection of the fully resolved spectrum can be associated for a suspect material and be exploited to identify such suspect materials. The HSI approach can yield a rapid, nondestructive, non-contact method for fingerprinting or identifying suspect materials of interest. In certain embodiments, suspect materials may include, for example chemicals, drugs, bio-threats or biohazards, such as viruses and bacteria, explosives, explosives residues and the like. The suspect materials for analysis can be found on or in a sample. In certain embodiments, the suspect materials can be found in or on samples including, for example, a passport, a credit card, a driver's license, a boarding pass, a human body part, a piece of clothing, a wearable item, a shoe, an airline ticket, luggage, personal effects and the like. Further, the suspect material may be present on items that have come in contact with a person or a person's personal effects. In another embodiment, the system and method disclosed herein may be used to identify and detect an Improvised Explosive Device (“IED”), a military grade explosive (“MGE”), a homemade explosive (“HME”) material, an emplacement, such as, DE and aged concrete, a command wire, an explosively formed penetrator (“EFP”) wire, an EFP camouflage, and items associated with an explosive compound and concealment. The system described herein may be upgraded to detect and identify new threat classes and materials by algorithm upgrades for such new threat classes and materials. In one embodiment, the upgrade may be accomplished in the field of operation. In certain embodiments, the suspect material may be present on a sample in either an indoor or outdoor scene.

The system described herein may be configured to operate in a range of wavelengths from about 700 nm to about 2,500 nm. In one embodiment, the system may be configured to operate in a wavelength range from about 700 nm to about 1,700 nm. In another embodiment, the system can be configured to operate in a wavelength range from about 850 nm to about 2,500 nm. In another embodiment, the system may be configured to operate in a wavelength range from about 850 nm to about 2,400 nm. In yet another embodiment, the system may be configured to operate in a wavelength range from about 900 nm to about 1,700 nm. As is apparent to those of skill in the art, the system described herein may be configured to operate in a wavelength range that includes any subset of wavelengths encompassed by the ranges disclosed herein, including any endpoints. In certain embodiments, the system incorporates at least two Liquid Crystal Tunable Filters (“LCTF”). LCTF's may be tuned to transmit narrow wavelength bands centered at any wavelength in the spectral range. This provides the HSI detector disclosed herein with access to hundreds of spectral bands to generate a fully resolved spectrum for every image pixel in the FOV. The absorption bands associated with the range of wavelengths disclosed herein generally result from overtones and combination bands of O—H, N—H, C—H, N—O and S—H stretching and bending vibrations. The molecular overtones and combination bands in the wavelength ranges are typically broad, leading to complex spectra where it can be difficult to assign specific chemical components to specific spectral features. However, HSI, as used herein, utilizes multivariate statistical processing techniques to provide a high degree of selectivity. HSI uses this selectivity to extract the important chemical information from the FOV and identify individual components of interest, such as a suspect material, based on a material's unique absorbance properties.

In practice, spectral imaging may feature four modules. The first is the lighting module (“LM”) where a light source is used to flood a sample area with a desired wavelength range of light where the sample area may include, for example, the tops and sides of a passenger's shoes. One or more standard halogen lamps may be employed as the illumination source where the illumination source is operable only when a spectral image is being generated. In some embodiments, the circumstances may dictate covert operation. In such a situation, the halogen lamps may be fitted with an appropriate longpass filter to remove the visible light portion of the halogen lamp output. The light or photons that have interacted with the tops and/or sides of the passenger's shoes are collected and analyzed in the optics module (“OM”).

The OM module may feature an appropriately sized lens or optic to collect the reflected light from the passenger or the passenger's personal effects, such as, for example, shoes. In a base chemical imaging system, the collected light is passed through the filter, such as, for example, a LCTF, whose bandpass wavelength can be set to a specific wavelength range, such as, for example, from about 700 nm to about 2,500 nm which permits selective detection and identification of a suspect material of interest. “Passband wavelength” as used herein refers to the wavelength transmitted by the respective filter. It is understood that, although a filter may transmit a particular passband, the filter may transmit a narrow range of wavelengths defined by the filter's full-width half maximum (“FWHM”) value. Different filters possess differing FWHM's. For example, a short-wave infrared filter may have a nominal FWHM of approximately 8 nm. The exact value of a filter's FWHM may vary and may depend on the area of the spectrum being filtered and upon the construction type of the filter, i.e., LCTF, MCF, etc. The final element in the OM is the focal plane array (FPA) or detector which detects the bandpass wavelength from the filter to generate a spectral image. In certain embodiments, the detector comprises a HSI detector where each of the images comprises the hypercube. In a specific embodiment, the HSI detector comprises an uncooled InGaAs FPA detector sensitive in the 900 nm to 1700 nm region.

Improved screening time and detection sensitivity may result by combining a dual polarization technique with spectral imaging. In certain embodiments, the dual polarization approach separates the incoming light or photons into a plurality of polarization orientations where each of the two or more orientations are directed to a filter, such as, for example, a LCTF, for wavelength selection and subsequently recombines the passband wavelength from each of the filters into a single FPA. This allows detection of two or more different wavelengths to be detected simultaneously. Since the screening time is proportional to the frame rate of the camera, this would result in a reduction of screening time of greater than fifty percent where a certain target material necessitates two wavelengths for detection.

As stated above, in one embodiment, an spectral imaging system operates over the 900 nm to 1,700 nm range. However, in another embodiment, the spectral imaging system may be configured to use longer wavelength (“extended range”) operation. This configuration may increase detection sensitivity. In one embodiment, the system employs a HSI detector comprising a cooled short-wave infrared FPA detector and an appropriate liquid crystal based LCTF, providing an operating range extending out to 2,400 nm.

The third spectral imaging module is the processing module (“PM”). This module houses the control and data processing electronics for the system and provides operating power for all of the system components. The PM is responsible for collecting the raw wavelength specific spectral data detected by the FPA detector to spatially resolved spectral signatures or images which are compared to a spectral library and trained against ambient background. Positive detections are obtained by comparing the spectral image to a signature library using pattern matching algorithms.

The final module in the spectral imaging module is the operator display unit (“ODU”). The ODU is the primary interface of spectral imaging with an operator or user of the system and may be tailored to the operator's specific needs. Here the results of any detections may be displayed as colored areas on an actual scene image, a stylized privacy image or a “yes” or “no” detection or identification of a suspect material. In one embodiment, the ODU can be a standalone module or can be integrated into the control or display system on an existing screening system or a sister detection system.

The systems and methods disclosed herein hold potential for a variety of applications including the detection and identification of suspect materials on an individual or on an individual's personal effects in a security setting including, for example, security checkpoints, such as, airport security, border security, stadium security, building security, transportation security, and other security settings as would be apparent in view of this disclosure. In one embodiment, the spectral imaging system disclosed herein contemplates the use of hyperspectral imaging technology to detect and identify chemical, biological, and explosive compounds in a non-contact, non-destructive configuration without requiring the use of chemical reagents.

In certain embodiments, application of the systems and methods described herein contemplate use in close proximity, standoff, and On-the-Move (“OTM”) configurations.

In another embodiment, the system may also be incorporated into other systems which are typically used in transportation and other security configurations, such as, for example, incorporation with body scanners at airports. Such an embodiment may include industry standard fusion software. Suitable fusion software is commercially available and includes, for example, ChemImage Corporation's (Pittsburgh, Pa.) Forensic Integrated Search Technology (“FIST”). This technology is more fully described in U.S. Pat. No. 8,112,248, filed on Jan. 22, 2008, entitled “Forensic Integrated Search Technology with Instrument Weight Factor Determination,” and U.S. Pat. No. 7,945,393, filed on Dec. 19, 2008, entitled “Detection of Pathogenic Microorganisms Using Fused Sensor Data”. Each of these applications is hereby incorporated by reference in its entirety.

In one embodiment, the system disclosed herein may provide an output to an operator or user of the system that is tailored to the specific application. For example, the system may be configured to inform an operator or user via, for example, a display indicating that a suspect material was detected or not detected in a sample. Further, in certain embodiments, an operator or user may be provided with a video image with colored overlays showing the type and location of the suspect material in the sample.

In certain embodiments, the system may be configured to operate using dual beam processing. Dual beam processing features passing an optical signal obtained from an illuminated sample through a plurality of filters (typically two or more filters) to process multiple components of the optical signal. In one embodiment, the filters may comprise a LCTF. In another embodiment, the filters may comprise a fixed filter. In one embodiment, the optical signal is split into two orthogonal polarization components prior to processing through at least two filters. The dual beam processing configuration maximizes the light or optical signal transmission ratio during spectrally filtered imaging using filters as described herein. Further, the use of dual polarization processing may decrease data acquisition and/or analysis time. In certain embodiments, the passband wavelength transmitted from each filter are the same passband wavelength. In other embodiments, the passband wavelength transmitted from each filter is a different passband wavelength.

In one embodiment, the system includes two or more LCTF's sensitive to a polarization orientation of an optical signal input from an objective lens. The optical signal input may be spectrally filtered by two or more LCTF's which are in optical communication to one or more collection optics. In certain embodiments, the collection optics are configured to collect a plurality of interacted photons from an illuminated sample and generate an optical signal from the interacted photons. In one embodiment, the optical signal may be passed through a beam splitter where the optical signal is separated into two or more optical components. In one embodiment, the two or more optical components are polarized. In another embodiment, the beam splitter separates the optical signal into the two optical components where the optical components are orthogonal to each other. In one embodiment, the beam splitter separates the optical signal into a first optical component and a second optical component where the first optical component is processed through a first LCTF and a second optical component is processed through a second LCTF. The first optical component and the second optical component processed through the respective LCTF's each transmit a passband wavelength corresponding to the passband wavelength for the respective filter. In one embodiment, the passband wavelength transmitted from the first LCTF and the passband wavelength transmitted from the second LCTF are the same passband wavelength. Where the LCTF's are tuned to the same passband wavelength, it is possible to maximize the intensity of this passband wavelength at the photodetector array (“detector”). In another embodiment, the passband wavelength transmitted from the first LCTF and the passband wavelength transmitted from the second LCTF are different passband wavelengths. In such an embodiment, it may be desired to tune the LCTF's to transmit different passband wavelengths where a suspect material may be characterized by two wavelength peaks where simultaneous detection of two passband wavelength peaks may decrease the detection time associated with the suspect material. For example, if two wavelength specific spectral images are displayed simultaneously for a sample characterized by two wavelength peaks, then the speed of detection becomes the frame rate of the camera. Such a configuration holds potential for detection in real time. In other embodiments where a material or object is characterized by n-number of wavelength peaks, then detection can be achieved in a shorter amount of time, for example, detection in half the amount of time.

The system further provides one or more detectors configured to detect the first optical signal and the second optical signal transmitted from the first LCTF and the second LCTF. In one embodiment, one detector is employed to detect both the first optical signal and the second optical signal transmitted from each of the first LCTF and the second LCTF. In another embodiment, two detectors are employed where a first detector is configured to detect the first optical component transmitted from the first LCTF and a second detector is configured to detect the second optical component transmitted from the second LCTF. The detector is further configured to generate one or more wavelength specific spectral images. In one embodiment, the system includes a display for displaying to a user the one or more wavelength specific spectral images generated by the detector. In another embodiment, the detector is configured to generate a wavelength specific hyperspectral image. In yet another embodiment, the display is configured to display the wavelength specific images in overlay and/or non-overlay configurations.

In certain embodiments, the system may be configured to orient two LCTF's orthogonally relative to one another and disposed to form an image through the same optics. The input light is split into its orthogonal plane polarized beams and each beam is aligned to the reference angle of one of the LCTF's. The resulting cross-polarized images are either overlaid on one another or displayed in a non-overlaid configuration.

According to one embodiment, the system may include an imaging lens or lens assembly and a plurality of spectral filters where the spectral filters rely on a polarization alignment. In particular, the spectral filter(s) may comprise two or more LCTF's. An imaging lens or lens assembly may be infinitely corrected or, in the alternative, the LCTF's may be disposed at a focal plane of the imaging lens or lens assembly. The objective lens collects interacted photons from the sample and generates an optical signal which is directed to a LCTF in a collimated optical signal, such as a collimated beam. In one embodiment the interacted photons are generated from, for example, laser-excited Raman radiation. In such an embodiment, a filter is inherently sensitive to polarization state. The optical components transmitted from the spectral filter is coupled through the imaging lens to be resolved on an image plane such as, for example, a CCD photosensor array.

In conventional LCTF configurations, the output optical component from the LCTF (i.e., the filtered output from the LCTF) is limited to one of two orthogonal polarization components of the collected photons or optical signal, which in the case of random polarization is 50% of the light power. However, in configurations of the instantly disclosed system, the dual processing configuration increases the intensity of the optical components transmitted from the LCTF's at a photodetector array.

In another embodiment, one polarization component of the optical signal generated from photons that have interacted with the sample may be transmitted directly through a polarization beam splitter. In this embodiment, the component is plane polarized and incident on the LCTF at the reference alignment of the LCTF. Therefore, this component is provided at the polarization alignment that obtains a maximum transmission ratio of the passband wavelength through the LCTF.

In an alternative embodiment, two orthogonally aligned optical signals and two orthogonally aligned LCTF's are employed. The input optical signal is split into two orthogonal oriented optical signals, as described above. The two LCTF's are placed along laterally adjacent optical signal paths. The first optical signal and corresponding LCTF operate as already described. The second LCTF on the second optical signal can be tuned to the same or a different wavelength. The second LCTF and the second optical signal can be oriented parallel to the first LCTF and preceded by a half wave plate at 45° so as to pre-orient the second optical signal. Or in another alternative, the half wave plate is omitted, and the second LCTF is physically rotated ±90° from parallel to the first LCTF. In embodiments where both LCTFs are tuned to the same wavelength, the first optical signal and second optical signals are cross-polarized and the overall signal (i.e., the combination of the first optical signal and second optical signal) intensity at the detector is at the maximum. When the first and second LCTF's are tuned to different wavelengths, the overall optical signal intensities are at half maximum at the detector. However, the dual polarization configuration of the present system enhances the contrast in a resulting wavelength specific spectral image generated by the detector.

In an alternative embodiment, the system includes a second collection optic in optical communication with a RGB image detector. The second collection optic collects photons generated from an illuminated sample and generates a RGB optical signal. The RGB detector is configured to detect the RGB optical signal and generate a RGB image of the sample. The RGB image may be analyzed by the processor. In one embodiment, the wavelength specific spectral image and the RGB image are presented on a display in an overlaid manner. Overlaying the wavelength specific spectral image over the RGB image may provide an operator or user of the system with an identification and/or detection of a suspect material and its location within the sample.

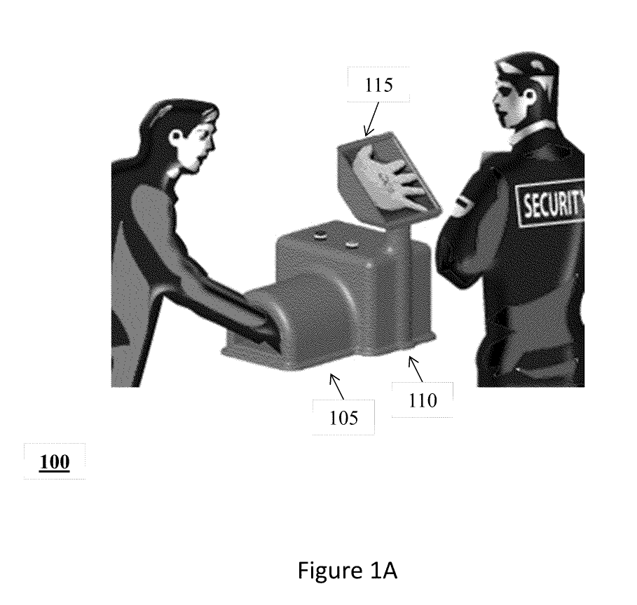

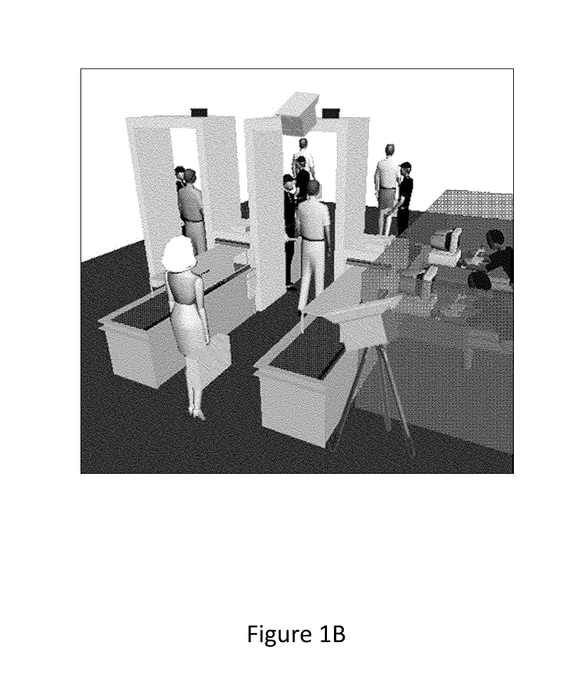

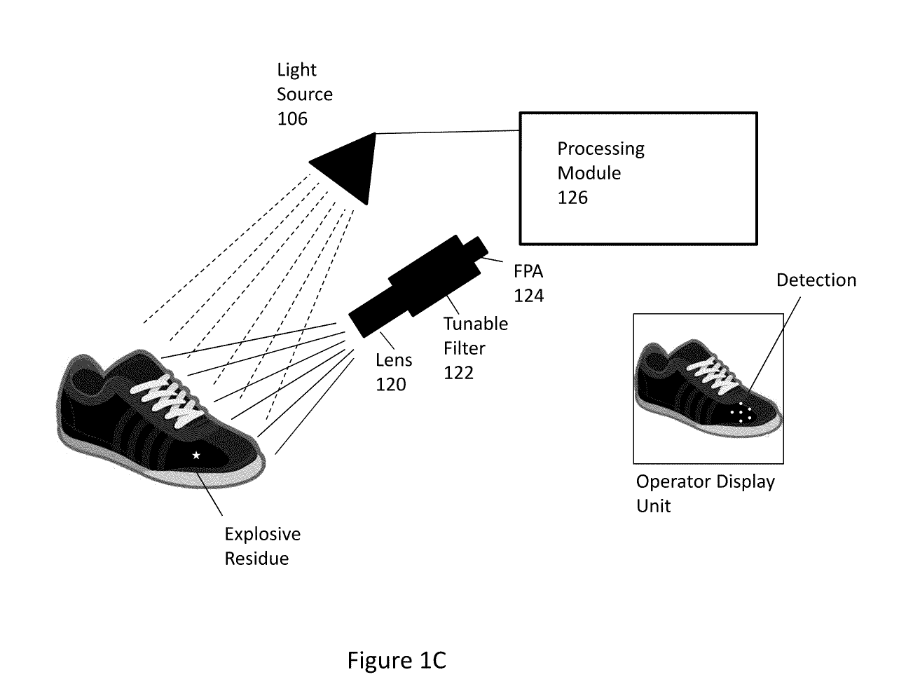

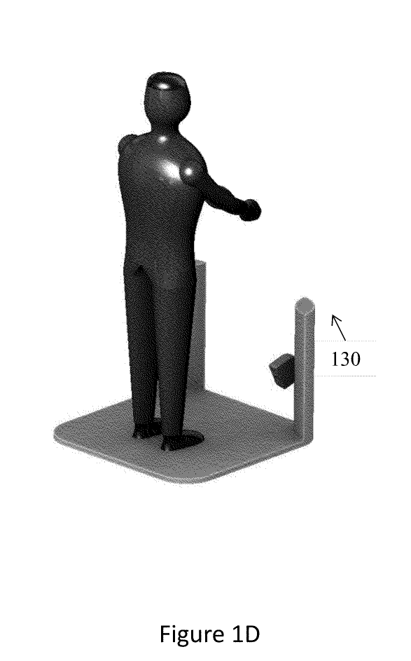

Several figures are provided to help illustrate various embodiments of a system and method disclosed herein. FIG. 1A illustrates an exemplary sensor system of the present disclosure. Sensor system 100 includes a sample chamber 105, a monitoring device 110 and a viewing screen 115. FIG. 1B is illustrative of another embodiment of the system. In such an embodiment, transportation passengers are sequentially or consecutively screened for suspect materials while passing through a security checkpoint. Such an embodiment may apply the standoff and OTM configurations discussed herein.

FIG. 1C is illustrative of another embodiment of the present disclosure. In such an embodiment, an illumination source 106 may be configured to illuminate a sample comprising a suspect material, such as, a suspected explosive material. The illumination source 106 may be an active illumination source or a passive illumination source. Interacted photons (including photons scattered, reflected, absorbed, and/or emitted by the sample) may be collected by a lens 120 and filtered by a LCTF 122. The photons may be detected by a detector 124, such as, for example, a focal plane array, and a hyperspectral image may be generated by the detector. A processing module 126 may compare the hyperspectral image and/or spectral information extracted from the image with reference data, wherein the reference data is associated with known materials. By comparing the hyperspectral image extracted from the spectral image with reference data of known hyperspectral images of known compounds, the processing module may identify and/or detect a suspect material.

FIG. 1D depicts an illustrative embodiment of a system incorporating the HSI device 130. The HSI device may be small, compact, portable and/or handheld. The HSI may be incorporated into a complementary system which utilizes a different detection technique.

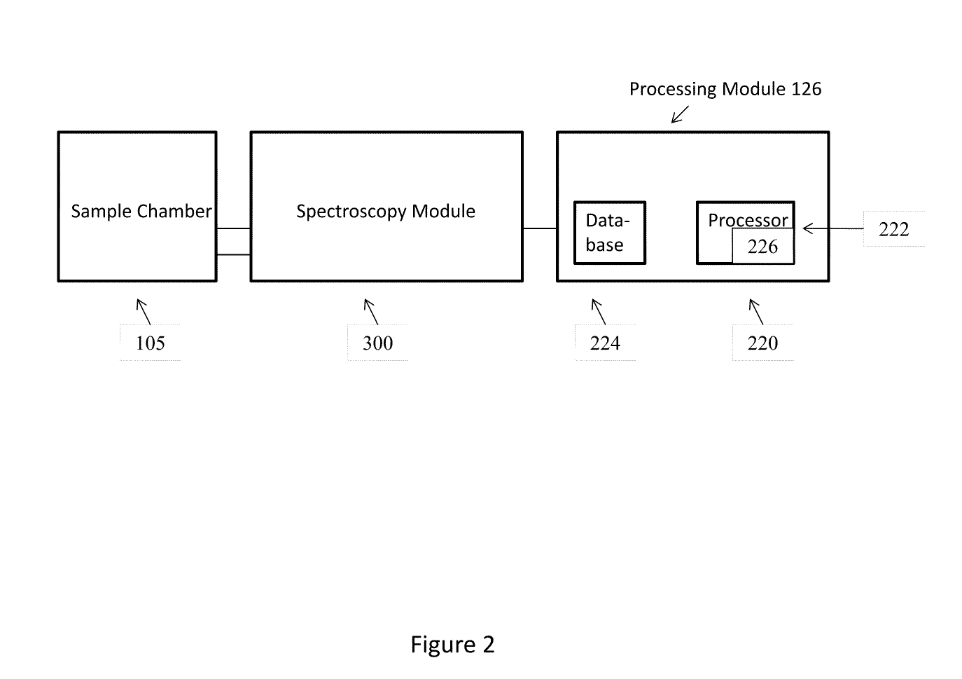

FIG. 2 illustrates a second exemplary detector system 200 of the present disclosure. Detector system 200 includes sample chamber 105, spectroscopy module 300 and processing module 220. Sample 201 is placed inside sample chamber 105 for analysis. Processing module 220 includes a processor 222, a database 224, and machine readable program code 226. In one embodiment, the detector system 200 may include one or more detectors. The detectors may include a digital device such as an image FPA, CCD or CMOS detector. The optical region employed to characterize the sample of interest governs the choice of a two-dimensional array detector. In other embodiments, gallium arsenide (“GaAs”) and Gallium indium arsenide (“GaInAs”) FPA detectors may be employed. The choice of such detectors may depend on the type of sample being analyzed. The machine readable program code 226 contains executable program instructions. The processor 222 is configured to execute the non-transitory machine readable program code 226 so as to perform the methods of the present disclosure.

Referring again to FIG. 2, hyperspectral data sets may be stored in the database 224 of processing module 220. In another embodiment, the processing module 220 may comprise at least one additional database. Such a database may comprise visible or RGB data sets. In another embodiment, the database 224 includes at least one of a plurality of known visible data sets and a plurality of known hyperspectral data sets. In one embodiment, the plurality of known visible data sets may comprise visible images including RGB and brightfield images. In one embodiment, the plurality of hyperspectral data sets may comprise at least one of a plurality of hyperspectral spectra and a plurality of spatially accurate wavelength resolved hyperspectral images. In certain embodiments, each known visible data set and each hyperspectral data set may be associated with a known compound. In one embodiment, the known compounds include suspect materials as disclosed herein, including an explosive compound, a residue of an explosive compound, a formulation additive of an explosive material, a binder of an explosive material, a biohazard, a chemical or an illegal drug. Representative known explosive compounds may include but are not limited to nitrocellulose, Ammonium nitrate (“AN”), nitroglycerin, 1,3,5-trinitroperhydro-1,3,5-triazine (“RDX”), 1,3,5,7 tetranitroperhydro-2,3,5,7-tetrazocine (“HMX”), NaNO₃, (NH₄)₂SO₄, KNO₃, KClO₃, NaHCO₃, and 1,3,-Dinitrato-2,2-bis(nitratomethyl) propane (“PETN”).

In one embodiment, the processor 222 may be configured to execute non-transitory machine readable program code 226 to search the database 224. The database 224 can be searched using a variety of similarity metrics. In one embodiment, the similarity metric produces a score. In certain embodiments, representative metrics include a principal component analysis, a multivariate curve resolution, a cosine correlation analysis, an Euclidian distance analysis, a partial least squares regression, a spectral mixture resolution, a spectral angle mapper metric, a spectral information divergence metric, a Mahalanobis distance metric and a spectral unmixing algorithm. A suitable spectral unmixing metric is disclosed in U.S. Pat. No. 7,072,770 entitled “Method for Identifying Components of a Mixture via Spectral Analysis,” which is hereby incorporated by reference in its entirety.

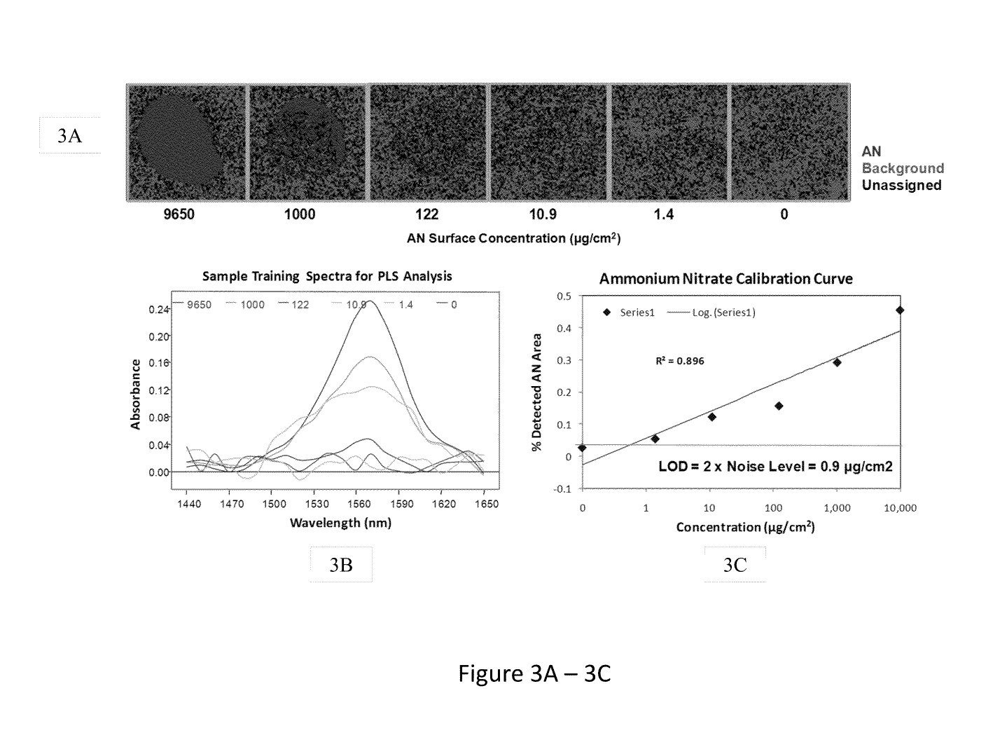

FIGS. 3A-3C illustrate a limit of detection (“LOD”) study for Ammonium Nitrate (“AN”) according to an embodiment. FIG. 3A represents the detection images associated with each of the samples prepared for use in the study. The darker pixels correspond to locations where AN has been deposited when evaluated using a partial least squares discriminant algorithm. FIG. 3B represents, the short-wave infrared spectra associated with varying concentrations of AN on aluminum. FIG. 3C represents a calibration curve plotting percent detected AN area versus log AN concentration indicating that the LOD for AN on aluminum at 30 m standoff range is 0.9 μg/cm².

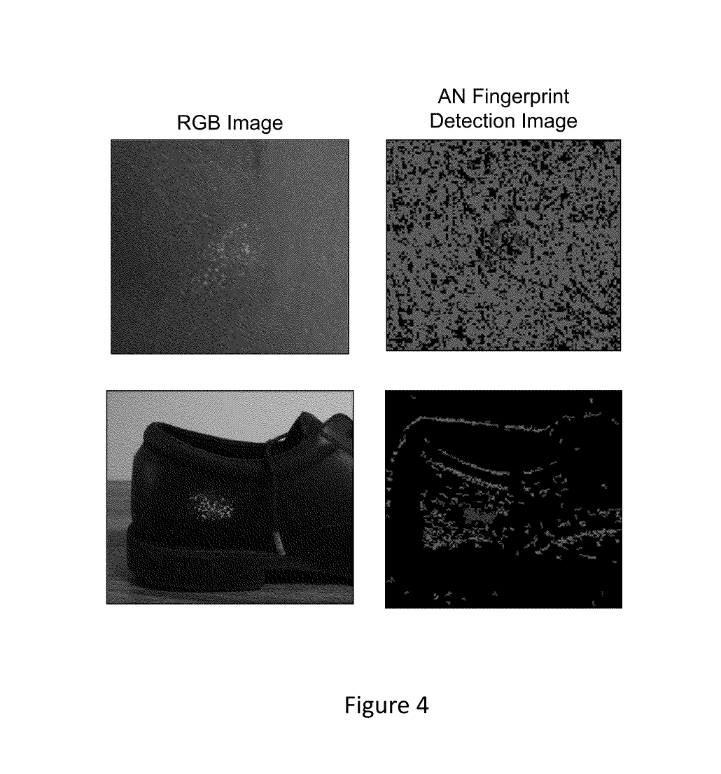

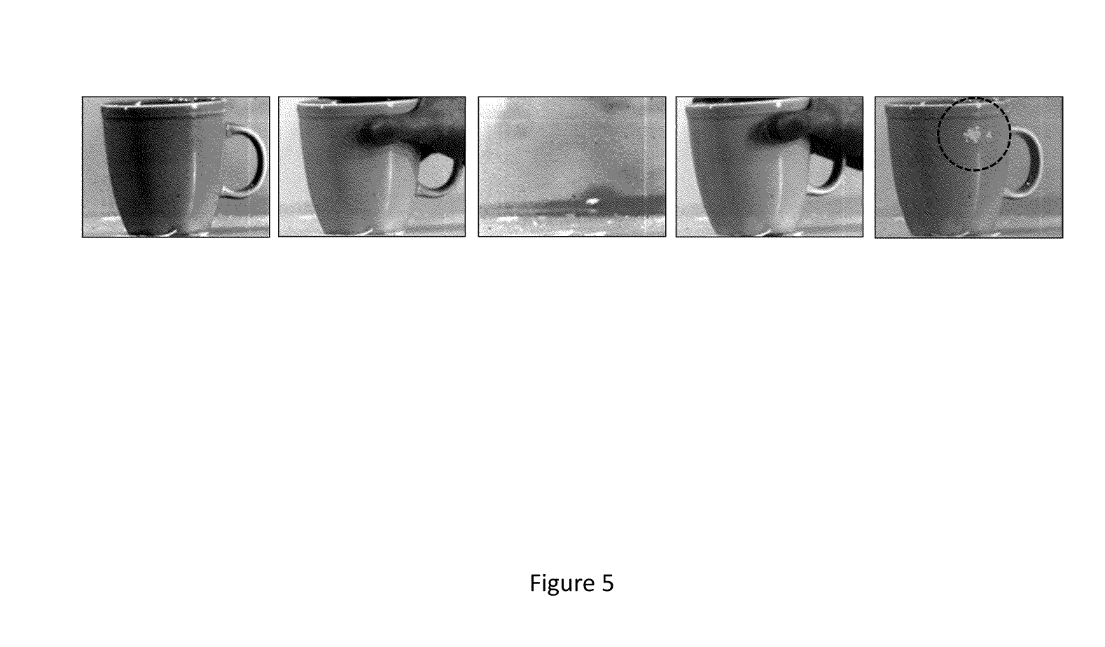

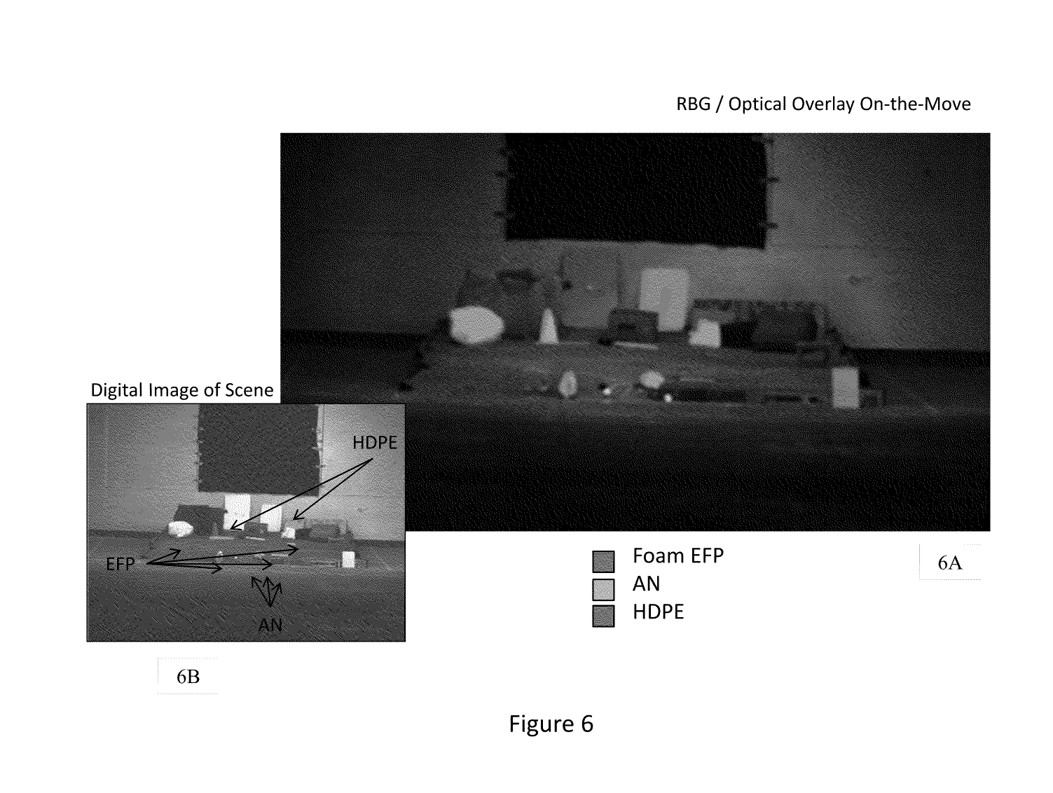

FIG. 4 illustrates the detection of Ammonium Nitrate (AN) residue on the surface of a leather shoe at 50 m standoff range according to an embodiment. FIG. 5 illustrates the detection of Ammonium Nitrate (AN) as it is deposited on the surface of a coffee cup at 30 meters range. This is illustrative of the system and method disclosed herein for detecting explosive materials on items that a passenger of interest may have come in contact with at a standoff distance. This detection enables scanning areas of a transportation station that are within the standoff range of the sensor and at security checkpoints. Such areas may include, for example, a waiting area, restaurant, ticket counter, and baggage claim. The system disclosed herein provides the ability to detect explosive material on items that may be left outside of the security checkpoint by a passenger, thereby, increasing the likelihood that a suspect material is detected. FIG. 6A illustrates an embodiment of the system herein where the sensor is moved from 40 meters to 10 meters for detecting AN “On-the-Move”. Multispectral data was collected from a standoff distance of 40 meters moving to 10 meters. In one embodiment, step scan data collection methodologies may be employed. In another embodiment, the data is processed offline. FIG. 6A represents a RGB/optical overlay OTM image. FIG. 6B represents an indoor test area.

Referring to dual polarization techniques, it is common in dual polarization systems to have an optical signal transmitted through a filter, such as, for example, a LCTF. The optical signal may be one of a required discrimination wavelength defined by the filter transmission characteristic, i.e., a comb filter, and may have a predetermined polarization alignment relative to the filter. An input polarization beam splitter may be placed immediately preceding the filter such that only plane polarized light aligned to the necessary reference input polarization angle is admitted to the filter. However, such an input polarization beam splitter is optional because operation of the filter relies on and selects for both the necessary polarization alignment and the necessary wavelength at the input. Thus, the filter transmits an optical signal that is parallel to the input polarization angle. Therefore, even light that is at the correct wavelength will be blocked by the filter if the polarization alignment of that light at the input to the filter is orthogonal to the predetermined input reference alignment of the filter. This has the adverse effect that if the input polarization orientation is random, then the maximum possible transmission ratio at the discrimination wavelengths is 50%.

The present disclosure provides polarizing independent optical signals wherein the transmission ratio is substantially improved by parallel processing of originally orthogonal polarization components through a plurality of spectral filters.

Suitable examples of polarization dependent spectral filters include the Lyot, Evans and Solc birefringent filter configurations. It is further possible to have a stacked filter configuration. There are three types of basic stacked polarization interference filters, including a Lyot filter, an Evan split-element filter and a Solc filter. A basic Lyot filter comprises a number of filter stages. where each stage comprises a fixed retarder bounded by linear polarizers. Another stacked polarization interference filter is the Evans split-element filter, wherein two stages of a Lyot filter may be combined into a single stage. In the Evans split-element filter, to eliminate a stage, the birefringent element for the stage to be eliminated is split in half and the split elements are positioned on either side of the birefringent element of another stage. In the Evans filter, the polarizers are crossed, and the center birefringent element is oriented parallel to either polarizer. Based on the configuration of Evans split-element filter, U.S. Pat. No. 6,091,462 provides split-element liquid crystal filters in wide-field, bandpass, cut-on, cut-off and notch filter configurations. Another basic configuration of a stacked polarization interference filter is the Solc filter. The Solc filter uses a cascade of identical phase retarders in each stage without the need for polarizers between each of the retarders. A Solc filter has two kinds of configurations: Solc fan arrangement and Solc folded arrangement. The first configuration, the Solc fan filter, has N identical retarders in each stage with rotation angles of θ3θ, 5θ, . . . (2N−1) θ located between parallel polarizers, where θ=π/4N. The other configuration, the Solc folded filter, has N-identical retarders in each stage with the optical axis of each retarder at ±θ° with respect to the entrance polarizer. In the Solc folded filter, the retarders are located between crossed polarizers. Tunable versions of spectral filters have been developed that include liquid crystal elements capable of being adjusted to define filter bandpass wavelengths. LCTF's with cascaded stages are disclosed, for example, in U.S. Pat. No. 6,992,809 to Wang et al., the disclosure of which is hereby incorporated by reference in its entirety. The U.S. Pat. No. 6,992,809 discloses embodiments of bandpass filters, which may be referred to as a multi-conjugate filter (“MCF”), that may use the Solc filter configurations, i.e., the Solc fan configuration and/or the Solc folded configuration. In one embodiment, multi-conjugate filters comprise a MCF utilizing ChemImage Multi-Conjugate Filter technology available from ChemImage Corporation, Pittsburgh, Pa. This technology is more fully described in U.S. Pat. No. 7,362,489, entitled “Multi-Conjugate Liquid Crystal Tunable Filter” and U.S. Pat. No. 6,992,809, also entitled “Multi-Conjugate Liquid Crystal Tunable Filter.” Each of which is hereby incorporated by reference in its entirety.

LCTFs are designed by using liquid crystal materials as the birefringent elements or using liquid crystal materials as tunable retarders combined with fixed retarders. In the Lyot, Evans split-element, and Solc configurations described above, it is observed that LCTF's are sensitive to the polarization state of incident light.

LCTF's are inherently sensitive to the polarization state of incident light and capture only one polarization of light, thereby immediately losing one half of the available light. LCTF's may include, but are not limited to, a MCF or any other polarization interference filter based configuration, such as, for example, the Lyot filter, the Evans split-element filter, the Solc filter, or filter configurations based on one or more of these filters. Furthermore, although the discussion herein is provided in the context of an LCTF that various other embodiments implementing filter configurations are contemplated. Such embodiments include filters that are not liquid crystal based or that may not be tunable. For example, in one embodiment, one or more fixed filters may be employed. Suitable liquid crystal filters contemplated herein may include, for example, a multi-conjugate liquid crystal tunable filter, an acousto-optical tunable filter, a Lyot liquid crystal tunable filter, an Evans split-element liquid crystal tunable filter, a Solc liquid crystal tunable filter, a ferroelectric liquid crystal tunable filter, a Fabry Perot liquid crystal tunable filter, and combinations thereof.

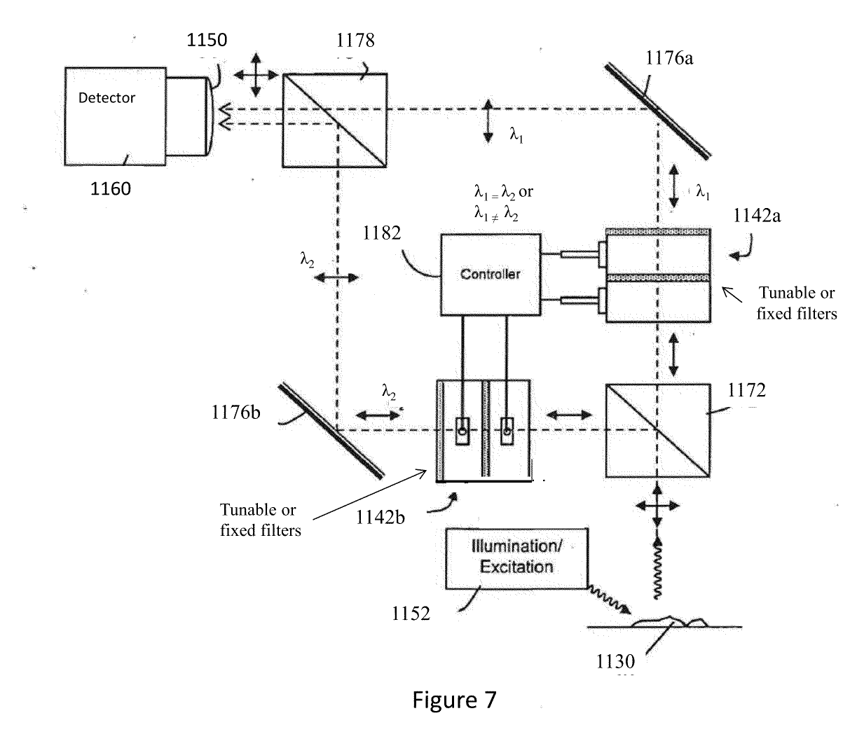

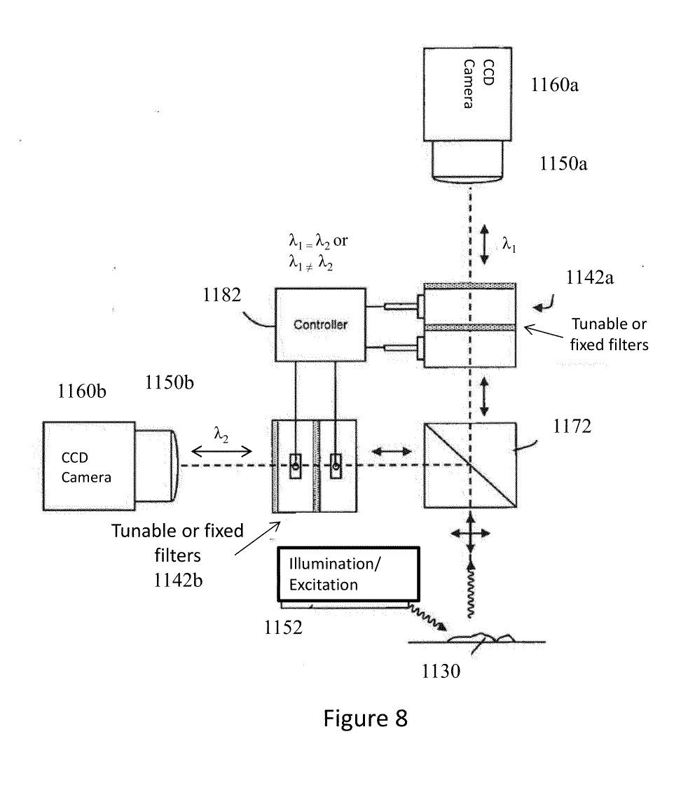

FIGS. 7 and 8 are provided to illustrate embodiments featuring dual polarization. Referring now to FIG. 7, a sample 1130 may be illuminated and/or excited by an illumination source 1125. In one embodiment, the illumination source 1125 may comprise a laser. In another embodiment, the illumination source 1125 may comprise a passive illumination source such as solar radiation. In one embodiment, it is possible to illuminate the sample from a laser directly in an oblique direction. The embodiment of FIG. 7 comprises two independently tunable LCTF's 1142a, 1142b along distinct orthogonal beam paths for the orthogonal polarization components emerging from polarizing cube 1172. In one embodiment, the LCTF's may comprise one or more of a multi-conjugate liquid crystal tunable filter, an acousto-optical tunable filter, a Lyot liquid crystal tunable filter, an Evans split-element liquid crystal tunable filter, a Solc liquid crystal tunable filter, a ferroelectric liquid crystal tunable filter, and a Fabry Perot liquid crystal tunable filter. In this arrangement, the paths of the filtered beams are not parallel through the LCTF's 1142a, 1142b, but are directed by appropriate reflectors, i.e., mirrors, 1176a, 1176b to a beam combiner 1178. In alternate embodiments, the beam combiner may be a polarizing cube or polarizing beam splitter. In another embodiment, the orthogonal components may comprise the same or different passband wavelengths λ₁ and λ₂. In one embodiment, the components may be combined and directed to a detector 1160 through a lens assembly 1150. In another embodiment, the components may be kept separate as they are directed to the detector 1160. In some embodiments, beam paths from the polarizing cube 1172 to the beam combiner 1178 via individual LCTFs 1142a, 1142b may be made symmetrical to avoid, for example, a need for infinitely-corrected optics.

In FIG. 7, the detector 1160 is illustrated as comprising a CCD detector. However, the present disclosure contemplates that the detector 1160 may comprise other suitable detectors including, for example, a CCD detector, a complementary metal-oxide-semiconductor CMOS detector, an indium gallium arsenide InGaAs detector, a platinum silicide PtSi detector, an indium antimonide (“InSb”) detector, a mercury cadmium telluride (“HgCdTe”) detector, or combinations thereof. Still referring to FIG. 7, the two LCTF's 1142a, 1142b may be tuned in unison to the same wavelengths (λ₁=λ₂) using an LCTF controller 1182. It is possible to configure the controller 1182 to independently tune each passband wavelength λ₁ and λ₂ of the LCTF's 1142a, 1142b to respectively process orthogonal components of the input. Therefore, by appropriate control, the LCTF's can be tuned to the same passband wavelength or to two different passband wavelengths (λ₁≠λ₂) at the same time. The controller 1182 may be programmable or software implemented to allow a user to selectively tune each LCTF 1142a, 1142b as desired. In the embodiment of FIG. 7, a fast switching mechanism (not shown) may be provided to switch between the two views (or spectral images) corresponding to spectral data collected by the detector 1160 from each of the tunable filter 1142a, 1142b. Alternatively, such two spectral views or images (from two separate LCTF's) may be combined or overlaid into a single image to increase contrast or intensity or for comparison purposes. The embodiment in FIG. 7 comprises a single CCD detector 1160 to capture the filtered signals received from the LCTFs 1142a, 1142b. In another embodiment, the beam combiner 1178 may be removed and two detectors may be used where each detector is configured to detect a filtered signal from one of the two LCTF's. An exemplary embodiment of such a configuration is illustrated in FIG. 8.

In FIG. 8, each detector 1160a and 1160b may be optically coupled to a corresponding one of the two LCTF's 1142a, 1142b to capture filtered signals from the LCTF and to responsively generate electronic signals that enable display of spectral images of the illuminated sample 1130. The present disclosure contemplates that any number of optical filters and associated detectors may be used to achieve the benefit of dual polarization as described herein. In one embodiment, the two filtered signals may be detected simultaneously. As discussed herein, simultaneous detection of two different wavelengths holds potential for real-time detection when displayed in a non-overlapping configuration, such as, for example, a side-by-side, or a top to bottom arrangement In another embodiment, the two filtered signals may be detected sequentially. It is noted here that although laser light may be coherent, the light received from the sample 1130, i.e., light emitted from the sample, light scattered from the sample, light absorbed from the sample, and/or light reflected from the sample, and directed through the LCTF's 1142a, 1142b may not be coherent. Therefore, wavefront errors may not be present or may be substantially avoided in the two LCTF versions in FIGS. 7 and 8 due to processing the non-coherent light through each LCTF 1142a, 1142b.

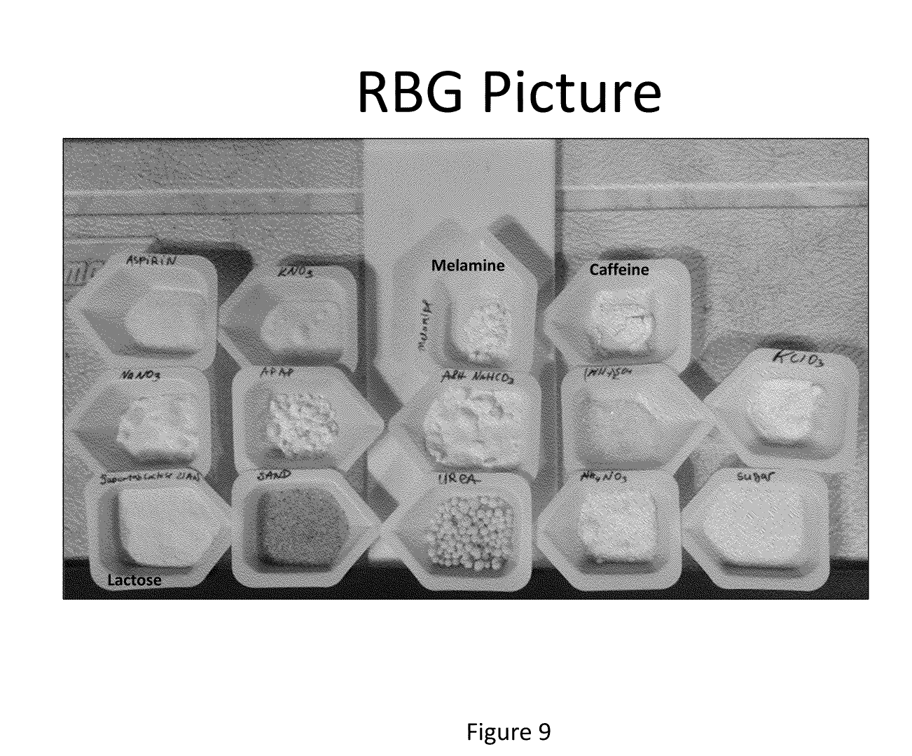

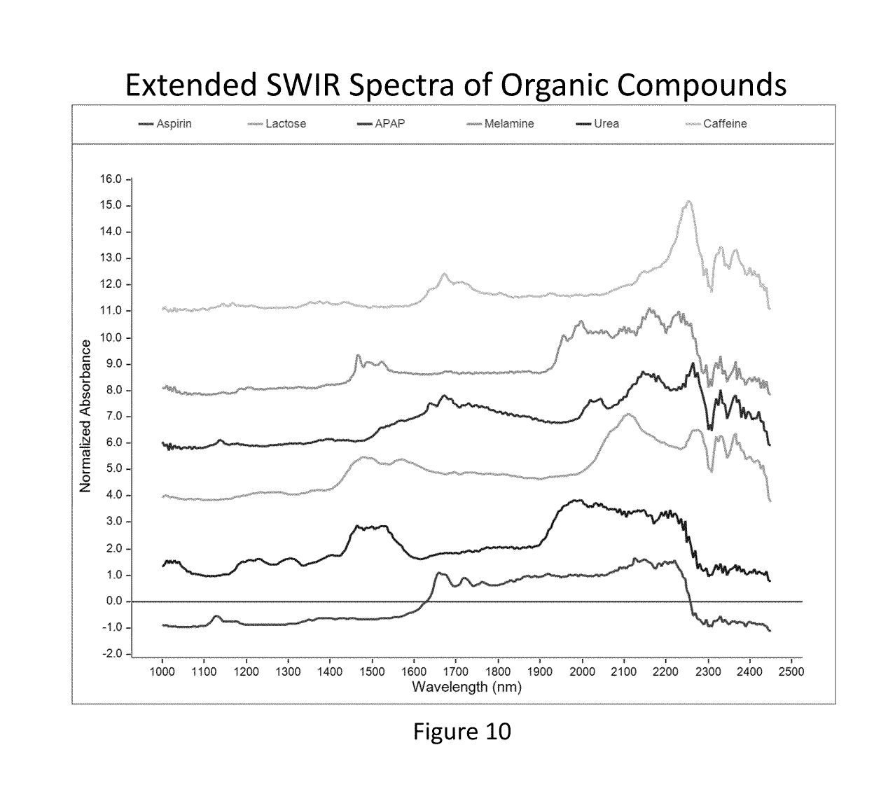

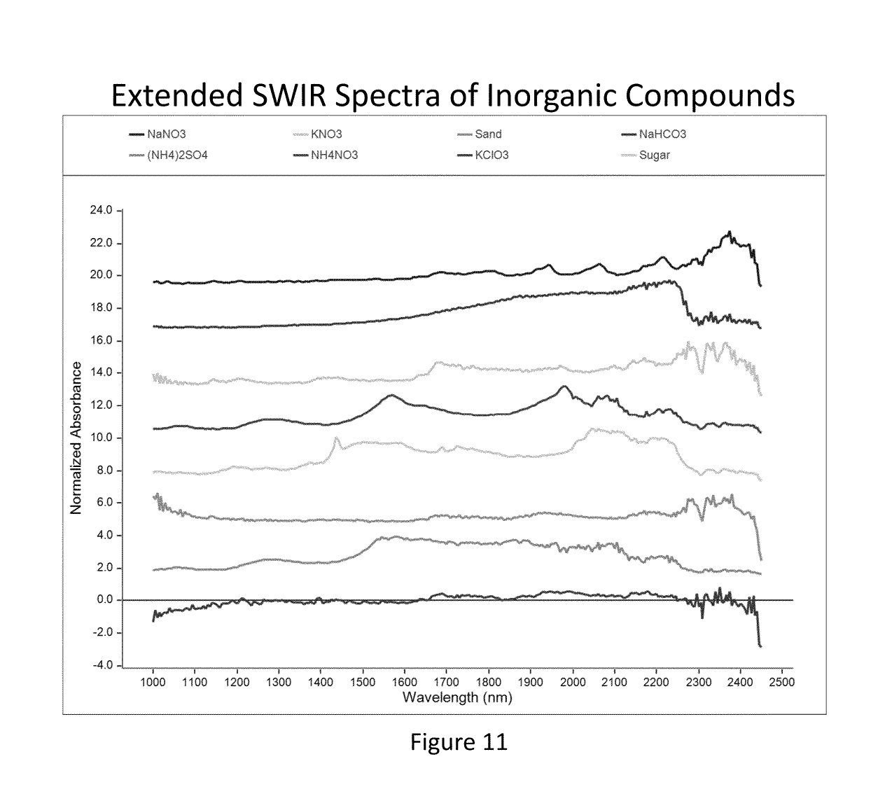

FIGS. 9, 10 and 11 illustrate RGB and spectral images captured by a system disclosed herein according to an embodiment. FIG. 9 illustrates a RGB image of several organic chemical compounds representing suspect materials. FIG. 10 and FIG. 11 illustrate extended short-wave infrared spectra of the organic compounds in the RGB image of FIG. 9 over a wavelength range from about 900 nm to about 2,500 nm. As is apparent, the spectra show unique signatures for each of the different organic compounds. The unique signatures permit the system to distinguish and identify each of the compounds. Further, in the extended range of the short wave infrared, i.e., from about 1,400 nm to about 2,500 nm, the spectra for each of the organic compounds show marked differences in their spectra over this range.

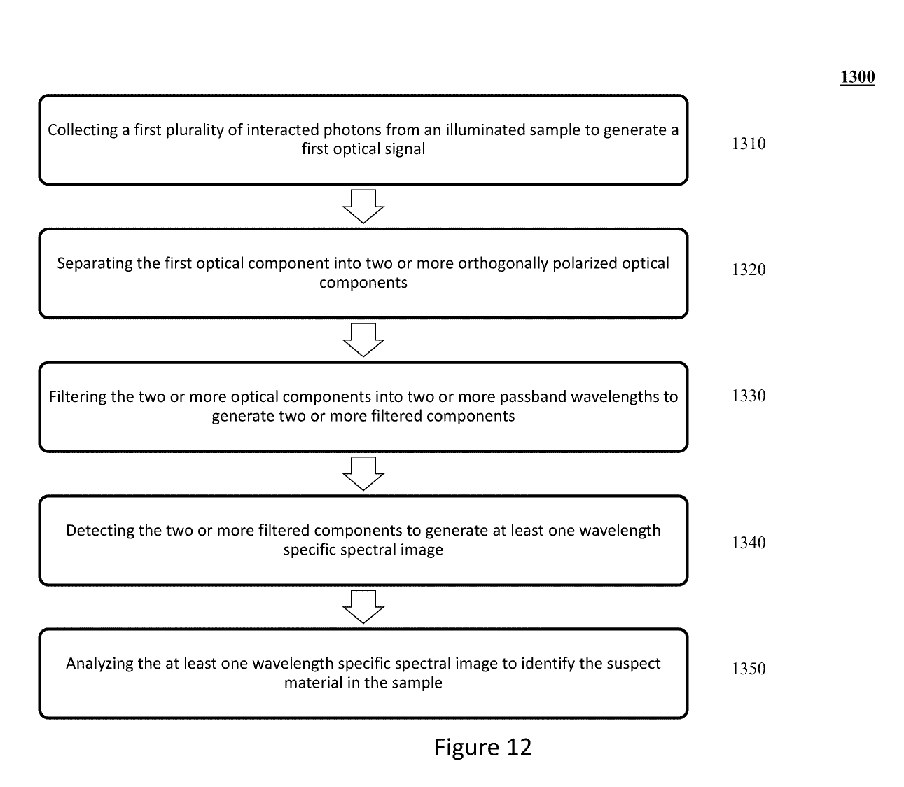

FIG. 12 illustrates a method 1300 for identifying a suspect material in a sample according to an embodiment comprising dual polarization. The method may comprise collecting 1310 a first plurality of interacted photons from an illuminated sample to generate a first optical signal. Interacted photons, as used herein, may comprise photons that are absorbed by the sample, photons reflected by the sample, photons emitted by the sample, photons scattered by the sample and combinations thereof. The sample, as used herein, may include any object such as, for example, a passport, a credit card, a driver's license, a boarding pass, a human body part, a piece of human clothing, a human-wearable item, a shoe, an airline ticket, and combinations thereof. In one embodiment, the sample may be illuminated using a passive illumination source, such as the sun. In another embodiment, the sample may be illuminated using an active illumination source. In one embodiment, the active illumination source is an active broadband illumination source. In one embodiment, the illumination source is an active illumination source including a tungsten white light illumination source.

The first optical signal is separated 1320 into two or more orthogonally polarized optical components. The two or more orthogonally polarized optical components are filtered 1330 into two or more passband wavelengths to generate two or more filtered components. The two or more filtered components are detected 1340 to generate at least one wavelength specific spectral image of the plurality of filtered components. In one embodiment, the image may comprise at least one of a short-wave infrared image, a near infrared image, and an extended range image and combinations thereof. In one embodiment, the image may comprise at least one of a near infrared image, a short wave infrared image, a mid-wave infrared image, a long wave infrared image, an extended range image, and combinations thereof. In another embodiment, the wavelength specific spectral image comprises a wavelength specific hyperspectral image. The at least one wavelength specific spectral image is analyzed 1350 to identify the suspect material in the sample. In one embodiment, the analysis 1350 includes searching a spectral image database to order to identify a known spectral image data set from the spectral image database. The spectral image database may contain a plurality of known spectral image data sets where each known spectral image data set is associated with a known material. In one embodiment, searching one or more RGB databases and one or more spectral image databases comprises applying a similarity metric. Such application may comprise generating a score representative of the likelihood of a match between the sample and the known spectral image data set. In one embodiment, this similarity metric may comprise a multivariate analysis method as disclosed herein. In another embodiment, the plurality of spectral data sets includes one or more of a plurality of spectral images corresponding to the suspect material and a plurality of spectral images corresponding to known materials.

In another embodiment, a second plurality of interacted photons may be detected by an RGB imaging device to generate a RGB image of the sample. The RGB image may be analyzed to identify an area of interest in the sample. In one embodiment, analyzing the RGB image further comprises searching a RGB database in order to identify a known RGB data set from the RGB database. The RGB database may contain a plurality of known RGB data sets, and each known RGB data set may be associated with one or more known materials. In one embodiment, the searching may comprise identifying attributes such as size, shape, color, and morphology. In another embodiment, the RGB data set may be analyzed by visual inspection. Visual inspection may comprise analyzing the RGB data set for size, shape, color and morphology. In one embodiment, the RGB data set comprises a visible image representative of the sample. In one embodiment, the RGB image may comprise one or more of a RGB image, a series of streaming RGB images, and a RGB video image. In another embodiment, the RGB image may be overlaid with the wavelength specific spectral image in order to identify the location of a suspect material in the sample.

The present disclosure may be embodied in other specific forms without departing from the spirit or essential attributes of the disclosure. Although the foregoing description is directed to the embodiments of the disclosure, it is noted that other variations and modifications will be apparent to those skilled in the art, and may be made without departing from the spirit of scope of the disclosure.

What is claimed is:

1. A security screening system for identifying a suspect material in a sample, the system comprising:
a first collection optic configured to collect a first plurality of interacted photons from an illuminated sample and generate a first optical signal from the interacted photons;
a beam splitter configured to separate the first optical signal into a plurality of optical components;
a plurality of filters, wherein each filter is configured to filter one of the plurality of optical components into a passband wavelength to generate a plurality of filtered components;
one or more detectors configured to detect the plurality of filtered components and generate one or more wavelength specific spectral images of the plurality of filtered components; and
a processor configured to analyze the one or more wavelength specific spectral images to identify the suspect material in the sample.

2. The system of claim 1, wherein the beam splitter is further configured to separate the first optical signal into a plurality of orthogonally polarized optical components.

3. The system of claim 1, wherein at least one of the plurality of filters is a liquid crystal tunable filter.

4. The system of claim 3, wherein the liquid crystal tunable filter comprises one or more of a multi-conjugate liquid crystal tunable filter, a Fabry Perot angle liquid crystal tunable filter, an acousto-optic liquid crystal tunable filter, a Loyt liquid crystal tunable filter, an Evans split element liquid crystal tunable filter, a Solc liquid crystal tunable filter, a ferroelectric liquid crystal tunable filter, and a Fabry Perot liquid crystal tunable filter.

5. The system of claim 1, wherein the passband wavelength for each of the plurality of filters is the same.

6. The system of claim 1, wherein the passband wavelength of each of the plurality of filters comprise is different.

7. The system of claim 1, wherein the one or more detectors comprise a hyperspectral detector.

8. The system of claim 1, wherein the one or more detectors are further configured to detect wavelengths ranging from about 700 nm to about 2,400 nm.

9. The system of claim 1, wherein the one or more detectors comprise one or more of a CCD detector, a complementary metal-oxide-semiconductor detector, an indium gallium arsenide (InGaAS) detector, a platinum silicide (PtSi) detector, an indium antimonide (InSb) detector, and a mercury cadmium telluride (HgCdTe) detector.

10. The system of claim 1, further comprising a beam combiner configured to combine the plurality of filtered components into a merged optical component.

11. The system of claim 10, wherein the merged optical component is detected by one of the one or more detectors.

12. The system of claim 1, wherein the plurality of filtered components are detected simultaneously.

13. The system of claim 1, wherein the plurality of filtered components are detected sequentially.

14. The system of claim 1, wherein the processor is configured to analyze the one or more wavelength specific spectral images in real-time.

15. The system of claim 1, further comprising a display configured to display the wavelength specific spectral image analysis obtained by the processor.

16. The system of claim 15, wherein the display is configured to display a plurality of wavelength specific spectral images in either an overlapping configuration or a non-overlapping configuration.

17. The system of claim 1, wherein the plurality of filters comprise one or more of a fixed filter and a tunable filter.

18. The system of claim 1, further comprising a half wave plate configured to pre-orient the first optical signal preceding one of the plurality of filters.

19. The system of claim 1, wherein a first filter of the plurality of filters is rotated ±90° from parallel with respect to a second filter of the plurality of filters.

20. The system of claim 1, wherein the processor is further configured to compare the one or more wavelength specific spectral images to one or more known wavelength specific spectral images to identify the suspect material in the sample.

21. The system of claim 20, further comprising a database comprising one or more reference data sets wherein each reference data set comprises known wavelength specific spectral images.

22. The system of claim 1, wherein the suspect material comprises one or more of a chemical, a drug, an explosive, an explosive residue, an explosive related compound, and a biohazard.

23. The system of claim 1, wherein the sample comprises one or more of a body part, a shoe, a passport, a credit card, a driver's license, a boarding pass, a piece of clothing, a wearable item, an airline ticket, luggage, and personal effects.

24. The system of claim 1, further comprising:
a second collection optic configured to collect a second plurality of interacted photons from an illuminated sample and generate a second optical signal; and
a RGB detector configured to detect the second optical signal and generate an RGB image of the second optical signal.

25. The system of claim 24, wherein the processor is further configured to analyze the RGB image and generate an overlaid representation of the one or more wavelength specific spectral images and the RGB image.

26. A security screening system for identifying a suspect material in a sample, the system comprising:
a first collection optic configured to collect a first plurality of interacted photons from an illuminated sample and generate a first optical signal of the interacted photons;
a beam splitter configured to separate the first optical signal into a first split optical signal and a second split optical signal, wherein the first split optical signal and the second split optical signal are aligned orthogonal to each other;
first and second tunable filters (“LCTF”), wherein the first LCTF is configured to filter the first split optical signal and transmit a first filtered component comprising a first passband wavelength and the second LCTF is configured to filter the second split optical signal and transmit a second filtered component comprising a second passband wavelength;
one or more hyperspectral detectors configured to detect the first filtered component and the second filtered component and generate one or more wavelength specific hyperspectral images of the first filtered component and the second filtered component; and
a processor configured to analyze the one or more wavelength specific hyperspectral images by comparing the one or more wavelength specific hyperspectral images to one or more known hyperspectral images to identify the suspect material in the sample.

27. The system of claim 26, further comprising a database comprising one or more reference data sets, wherein each reference data set comprises known wavelength specific hyperspectral images.

28. The system of claim 26, wherein the beam splitter is further configured to separate the first optical signal into a plurality of polarized optical components.

29. The system of claim 26, wherein the liquid crystal tunable filter comprises one or more of a multi-conjugate liquid crystal tunable filter, a Fabry Perot angle liquid crystal tunable filter, an acousto-optic liquid crystal tunable filter, a Loyt liquid crystal tunable filter, an Evans split element liquid crystal tunable filter, a Solc liquid crystal tunable filter, a ferroelectric liquid crystal tunable filter, and a Fabry Perot liquid crystal tunable filter.

30. The system of claim 26, wherein the first passband wavelength and the second passband wavelength comprise the same wavelength.

31. The system of claim 26, wherein the first passband wavelength and the second passband wavelength comprise different wavelengths.

32. The system of claim 26, wherein the one or more hyperspectral detectors are configured to detect wavelengths ranging from about 700 nm to about 2,400 nm.

33. The system of claim 26, wherein the one or more hyperspectral detectors are configured to detect wavelengths ranging from about 900 nm to about 2,400 nm.

34. The system of claim 26, wherein the one or more hyperspectral detectors comprise one or more of a CCD detector, a complementary metal-oxide-semiconductor detector, an indium gallium arsenide (InGaAS) detector, a platinum silicide (PtSi) detector, an indium antimonide (InSb) detector, and a mercury cadmium telluride (HgCdTe) detector.

35. The system of claim 26, further comprising a beam combiner configured to combine the first filtered component and the second filtered component into a merged optical component.

36. The system of claim 35, wherein the merged optical component is detected by one of the one or more hyperspectral detectors.

37. The system of claim 26, wherein the first filtered component is detected by a first hyperspectral detector and the second filtered component is detected by a second hyperspectral detector.

38. The system of claim 26, wherein the first filtered component and the second filtered component are detected simultaneously.

39. The system of claim 26, wherein the first filtered component and the second filtered component are detected sequentially.

40. The system of claim 26, wherein the processor is configured to analyze the one or more wavelength specific hyperspectral images in real-time.

41. The system of claim 26, further comprising a display configured to display the one or more wavelength specific hyperspectral image analyzed by the processor.

42. The system of claim 41, wherein the display is configured to display a plurality of wavelength specific hyperspectral images in an overlapping configuration or a non-overlapping configuration.

43. The system of claim 26, further comprising a half wave plate configured to pre-orient the first optical signal preceding one of the first LCTF and the second LCTF.

44. The system of claim 26, wherein the first LCTF is rotated ±90° from parallel with respect to the second LCTF.

45. The system of claim 26, wherein the suspect material comprises one or more of a chemical, a drug, an explosive, an explosive residue, an explosive related compound, and a biohazard.

46. The system of claim 26, wherein the sample comprises one or more of a body part, a shoe, a passport, a credit card, a driver's license, a boarding pass, a piece of clothing, a wearable item, an airline ticket, luggage, and personal effects.

47. The system of claim 26, further comprising:
a second collection optic configured to collect a second plurality of interacted photons from an illuminated sample and generate a second optical signal; and
a RGB detector configured to detect the second optical signal and generate a RGB image of the second optical signal.

48. The system of claim 47, wherein the processor is further configured to analyze the RGB image and generate an overlaid representation of the one or more wavelength specific spectral images and the RGB image.

49. A method for identifying a suspect material in a sample, the method comprising:
collecting a first plurality of interacted photons from an illuminated sample to generate a first optical signal;
separating the first optical signal into a plurality of orthogonally polarized optical components;
filtering the plurality of optical components into a plurality of passband wavelengths to generate a plurality of filtered components;
detecting the plurality of filtered components to generate at least one wavelength specific spectral image; and
analyzing the at least one wavelength specific spectral image to identify the suspect material in the sample.

50. The method of claim 49, wherein the plurality of filtered components comprise the same passband wavelength.

51. The method of claim 49, wherein the plurality of filtered components comprise different passband wavelengths.

52. The method of claim 49, wherein the wavelength specific spectral image comprises a wavelength specific hyperspectral image.

53. The method of claim 48, wherein detecting the plurality of filtered components comprises detecting at wavelengths ranging from about 700 nm to about 2,400 nm.

54. The method of claim 48, further comprising recombining the plurality of filtered components into a merged optical component.

55. The method of claim 48, further comprising:
collecting a second plurality of interacted photons that have interacted with an illuminated sample and generate a second optical signal; and
detecting the second optical signal to generate an RGB image of the second optical signal.

56. The method of claim 55, further comprising analyzing the RGB image and displaying an overlay of the RGB image and the wavelength specific spectral image.
